(19) United States
(12) Patent Application Publication
(10) Pub. No.: US 2007/0236095 A1
(43) Pub. Date: Oct. 11, 2007

(54) Electric motor apparatus

(76) Inventor: Joseph C. Caiozza, Long Beach, NY (US)

Correspondence Address: S. Michael Bender, P.O. Box 530-399, S.t Petersburg, FL, 33747, US

(21) Appl. No.: 11/400,591

(22) Filed: Apr. 10, 2006

(51) Int. Cl. H02K 21/26; H02K 21/00; H02K 13/00

(52) U.S. Cl. 310/219; 310/266; 310/154.49; 310/232; 310/191

(57) ABSTRACT

A DC electric motor apparatus includes a stationary magnet set which includes an outer, hollow-cylindrical stationary magnet set portion and an inner, solid-cylindrical stationary magnet set portion centrally located inside the outer, hollow-cylindrical stationary magnet set portion, wherein an armature-nesting space is located between the outer, hollow-cylindrical stationary magnet set portion and the inner, solid-cylindrical stationary magnet set portion. A rotatable armature assembly includes a hollow-cylindrical armature winding set which is received in the armature-nesting space. A drive assembly is connected to the rotatable armature assembly. Electric current pickup means are electrically connected to the rotatable armature assembly. Housing means are provided for housing the stationary magnet set, the rotatable armature assembly, a portion of the drive assembly, and a portion of the electric current pickup means. The electrical magnetic fields in the rotatable armature assembly interact with the permanent magnetic fields in both the outer, hollow-cylindrical stationary magnet set portion and the inner, solid-cylindrical stationary magnet set portion to provide a powerful motor.

### BACKGROUND OF THE INVENTION

1. Field of the Invention

The present invention relates generally to electric motors, and, more particularly, to direct current (DC) electric motors.

2. Description of the Prior Art

With ordinary DC electric motors, armature poles are mounted around a common drive shaft. The armature poles, with wire windings, meet at the common drive shaft and cancel magnetic fields, inducted into the poles by putting an electric current through the wire windings. The outer portion of the armature poles are not affected, so when current flows through the wire windings, the magnetic fields cause the armature pole pieces to be either attracted to or repelled by the permanent magnets that surround the armature, causing the armature poles and the common drive shaft to rotate, providing motor action.

With an ordinary DC electric motor, a segmented commutator electrically connects the wires of the armature together so that the alternating direction of the wire wound poles, cause the magnetic fields to change polarity, first attracting then repelling the armature to the permanent magnets, causing the armature and the common drive shaft to rotate. This work produces heat that lowers the magnetic strength of the permanent magnets and increases the resistance of the wire that is wound around the armature poles.

With an ordinary DC motor, the brushes are in a fixed position which is a compromise with respect to a number of factors. The brushes carrying the electric current into the motor across the commutator that is spinning on the drive shaft of the motor. The brushes wear down due to the friction between the brushes and the commutator. The friction is desirable in that is provides good electric current flow between the brushes and the commutator.

No motor is one hundred percent efficient. One cause of inefficiency of an ordinary DC electric motor is the neutralization of magnetic fields inside the motor. In this respect, it would be desirable if a DC electric motor were provided which has improved efficiency. Stated somewhat differently, it would be desirable if an AC electric motor were provided which provides a more efficient and more powerful electric motor which uses no more electricity than an ordinary electric motor.

Some ordinary electric motors lose considerable efficiency and power when applied to power devices that have variable loads and speeds, such as cars, trucks, and other types of vehicles. In this respect, it would be desirable to provide an AC electric motor which has design features to improve efficiency and power when applied to power devices that have variable loads and speeds, such as cars, trucks, and other types of vehicles.

Still other features would be desirable in an DC electric motor apparatus. It would be desirable to be able to change the timing of contact between the brushes and the commutator in response to variations in vehicle load and speed.

To handle overheating of electric motors, some motors are provided with liquid cooling systems. In this respect, it would be desirable to change the timing of contact between the brushes and the commutator without interference from structures in the liquid cooling system.

Thus, while the foregoing discussion indicates it to be well known to use DC electric motors, the discussion does not teach or suggest an DC electric motor apparatus which has the following combination of desirable features: (1) provides an DC electric motor which has improved efficiency; (2) provides a more efficient and more powerful electric motor which uses no more electricity than an ordinary electric motor; (3) provides improved efficiency and power when applied to power devices that have variable loads and speeds, such as cars, trucks, and other types of vehicles; (4) is able to change the timing of contact between the brushes and the commutator in response to variations in vehicle load and speed; and (5) changes the timing of contact between the brushes and the commutator without interference from structures in the liquid cooling system. The foregoing desired characteristics are provided by the unique electric motor apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides an AC electric motor apparatus which includes a stationary magnet set which includes an outer, hollow-cylindrical stationary magnet set portion and an inner, solid-cylindrical stationary magnet set portion centrally located inside the outer, hollow-cylindrical stationary magnet set portion, wherein an armature-nesting space is located between the outer, hollow-cylindrical stationary magnet set portion and the inner, solid-cylindrical stationary magnet set portion. A rotatable armature assembly includes a hollow-cylindrical armature winding set which is received in the armature-nesting space. A drive assembly is connected to the rotatable armature assembly. Electric current pickup means are electrically connected to the rotatable armature assembly. Housing means are provided for housing the stationary magnet set, the rotatable armature assembly, a portion of the drive assembly, and a portion of the electric current pickup means. The electrical magnetic fields in the rotatable armature assembly interact with the permanent magnetic fields in both the outer, hollow-cylindrical stationary magnet set portion and the inner, solid-cylindrical stationary magnet set portion to provide a powerful motor.

Preferably, the outer, hollow-cylindrical stationary magnet set portion includes a plurality of outer-shunt-to-inner-shunt magnets distributed peripherally around the inner, solid-cylindrical stationary magnet set portion. A plurality of inner-shunt-to-inner-shunt magnets are distributed peripherally around the inner, solid-cylindrical stationary magnet set portion. A plurality of outside, contoured magnet shunts are distributed peripherally around the inner, solid-cylindrical stationary magnet set portion. A plurality of inside magnet shunts are distributed peripherally around the inner, solid-cylindrical stationary magnet set portion.

Preferably, each of the outside, contoured magnet shunts includes a pair of magnet-reception contours which receive respective ends of the outer-shunt-to-inner-shunt magnets. Each of the inside magnet shunts includes a pair of outer magnet-reception contours for receiving respective ends of the outer-shunt-to-inner-shunt magnets and includes a pair of side magnet-reception contours for receiving respective ends of the inner-shunt-to-inner-shunt magnets. The outer-shunt-to-inner-shunt magnets are arranged in two subsets of magnets, and the outer-shunt-to-inner-shunt magnets in one subset are oriented in opposite polarity directions to the outer-shunt-to-inner-shunt magnets in the other subset.

Preferably, the inner, solid-cylindrical stationary magnet set portion includes a plurality of outer-shunt-to-inner-shunt magnets which are distributed radially inside the outer, hollow-cylindrical stationary magnet set portion. A plurality of inner-shunt-to-inner-shunt magnets are distributed radially inside the outer, hollow-cylindrical stationary magnet set portion. A plurality of inside magnet shunts are distributed radially inside the outer, hollow-cylindrical stationary magnet set portion. A plurality of outside magnet shunts are distributed radially inside the outer, hollow-cylindrical stationary magnet set portion.

Each of the inside magnet shunts includes a pair of magnet-reception contours which receive respective ends of the outer-shunt-to-inner-shunt magnets. Each of the outside magnet shunts includes a pair of inner magnet-reception contours for receiving respective ends of the outer-shunt-to-inner-shunt magnets and includes a pair of side magnet-reception contours for receiving respective ends of the inner-shunt-to-inner-shunt magnets. The outer-shunt-to-inner-shunt magnets are arranged in two subsets of magnets, and the outer-shunt-to-inner-shunt magnets in one subset are oriented in opposite polarity directions to the outer-shunt-to-inner-shunt magnets in the other subset.

Preferably, the rotatable armature assembly includes

a rear support plate, a front support plate, and the hollow-cylindrical armature winding set is supported between the rear support plate and front support plate and distributed within the armature-nesting space. The drive assembly is connected to the rear support plate.

Preferably, the hollow-cylindrical armature winding set includes plural armature winding assemblies. Each of the armature winding assemblies includes a plurality of pole and coil units which are electrically connected together.

Preferably, each pole and coil unit includes a top pole portion, a wire-reception post connected to the top pole portion, a bottom pole portion connected to the wire-reception post, a wire coil supported by the wire-reception post, and armature wires connected between respective wire coils. Also, the hollow-cylindrical armature winding set includes a pair of coil-to-commutator wires connected to a selected pair of the pole and coil units.

Preferably, the drive assembly includes a motor shaft connected to the rear support plate. External drive shaft splines are located at a distal end of the motor shaft, and a drive gear includes internal drive gear splines that engage the external drive shaft splines.

Preferably, the electric current pickup means include an inner tubular axle which includes wire-reception channels. The inner tubular axle is supported by the rotatable armature assembly. A commutator is connected to a front end of the inner tubular axle. A movable brush mounting plate supported by the housing means, and roller brushes, supported by the movable brush mounting plate, are provided for contacting the commutator. The commutator is electrically connected to coil-to-commutator wires.

Preferably, the roller brushes are located at positions opposite to each other with respect to the center of the movable brush mounting plate and the commutator.

Preferably, the roller brushes are set at a small angle off of normal to the commutator, whereby the roller brushes provide both a sliding contact and a rolling contact with the commutator.

Preferably, the commutator includes a plurality of commutator segments.

Preferably, the commutator segments are bias cut to align with the rolling edge surfaces of the brushes in contact therewith.

A pair of multiple-arm internal contact feeder shunts are connected between coil-to-commutator wires and the commutator segments. The multiple-arm internal contact feeder shunts are housed inside the commutator and electrically contact respective commutator segments therein.

The pair of multiple-arm internal contact feeder shunts includes a first multiple-arm internal contact feeder shunt connected to one of the coil-to-commutator wires, wherein the first multiple-arm internal contact feeder shunt includes pairs of first contact arms that are positioned opposite to each other around an arm center. The oppositely-positioned pairs of first contact arms are electrically connected to a first plurality of commutator segments. A second multiple-arm internal contact feeder shunt is connected to the other of the coil-to-commutator wires, wherein the second multiple-arm internal contact feeder shunt includes pairs of second contact arms that are positioned opposite to each other around an arm center. The oppositely-positioned pairs of second contact arms are electrically connected to a second plurality of commutator segments.

Each commutator segment in the first plurality of commutator segments is interspersed between two commutator segments in the second plurality of commutator segments, and each commutator segment in the second plurality of commutator segments is interspersed between two commutator segments in the first plurality of commutator segments.

Brush-mounting plate movement means, supported by the housing means, are provided for rotating the movable brush mounting plate. Preferably, the brush-mounting plate movement means include gear teeth located at the circumference of the movable brush mounting plate, a servo motor controller which can be supported by the housing means, a servo motor controlled by the servo motor controller, and a servo-powered gear wheel driven by the servo motor. Rotation of the servo-powered gear wheel controls rotation of the movable brush mounting plate.

Preferably, compression springs are supported by the movable brush mounting plate and are connected to the roller brushes for pressing the roller brushes on the commutator.

Preferably, the housing means include a front support end plate, a rear support end plate, a first outer housing jacket, and a first inner housing jacket. More specifically, the outer, hollow-cylindrical stationary magnet set portion and the inner, solid-cylindrical stationary magnet set portion are supported between the front support end plate and the rear support end plate. The first outer housing jacket and the first inner housing jacket house the outer, hollow-cylindrical stationary magnet set portion.

Preferably, the rear support end plate includes air vent holes.

The housing means further include a second inner jacket and a second outer jacket. The second inner jacket and the second outer jacket are supported by the front support end plate, and the second inner jacket and the second outer jacket house the inner, solid-cylindrical stationary magnet set portion. Preferably, each of the front support end plate and the rear support end plate includes support feet.

Preferably, rollers are attached to the front support end plate, and a roller-reception flange is attached to the rotatable armature assembly, wherein the rollers ride on the roller-reception flange. The rollers and the roller-reception flange (non-ferrous) provide for the rotatable armature assembly to rotate within the armature-nesting space.

Preferably, a first liquid cooling system is provided for cooling the outer, hollow-cylindrical stationary magnet set portion, and a second liquid cooling system is provided for cooling the inner, solid-cylindrical stationary magnet set portion.

More specifically, the first liquid cooling system includes outer liquid cooling inlet/outlet tubes, and a first coolant flow chamber is connected to the outer liquid cooling inlet/outlet tubes. The first coolant flow chamber is defined by a first outer housing jacket, a first inner housing jacket, and a rear support end plate.

The second liquid cooling system includes inner liquid cooling inlet/outlet tubes and a second coolant flow chamber connected to the inner liquid cooling inlet/outlet tubes. The second coolant flow chamber is defined by a second outer jacket, a second inner jacket, and a rear second chamber wall.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved electric motor apparatus which has all of the advantages of the prior art and none of the disadvantages.

It is another object of the present invention to provide a new and improved electric motor apparatus which may be easily and efficiently manufactured and marketed.

It is a further object of the present invention to provide a new and improved electric motor apparatus which is of durable and reliable construction.

An even further object of the present invention is to provide a new and improved electric motor apparatus which is susceptible of a low cost of manufacture with regard to both materials and labor, and which accordingly is then susceptible of low prices of sale to the consuming public, thereby making such electric motor apparatus available to the buying public.

Still yet a further object of the present invention is to provide a new and improved electric motor apparatus which provides an DC electric motor which has improved efficiency.

Still another object of the present invention is to provide a new and improved electric motor apparatus that provides a more efficient and more powerful electric motor which uses no more electricity than an ordinary electric motor.

Yet another object of the present invention is to provide a new and improved electric motor apparatus which provides improved efficiency and power when applied to power devices that have variable loads and speeds, such as cars, trucks, and other types of vehicles.

Even another object of the present invention is to provide a new and improved electric motor apparatus that is able to change the timing of contact between the brushes and the commutator in response to variations in vehicle load and speed.

Still a further object of the present invention is to provide a new and improved electric motor apparatus which changes the timing of contact between the brushes and the commutator without interference from structures in the liquid cooling system.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a preferred embodiment of the electric motor apparatus of the invention.

FIG. 2 is a bottom view of the embodiment of the electric motor apparatus shown in FIG. 1 taken along line 2-2 of FIG. 1.

FIG. 3 is a cross-sectional view of the embodiment of the electric motor apparatus of FIG. 1.

FIG. 4 is a rear view of the outer, stationary magnet set and the inner, stationary magnet set removed from the electric motor apparatus.

FIG. 5 is an enlarged rear view of the inner, stationary magnet set shown in FIG. 4.

FIG. 5A is a partial perspective view of one group of the inner, stationary magnet set shown in FIG. 5.

FIG. 5B is another perspective view of the group of the inner, stationary magnet set shown in FIG. 5A.

FIG. 6 is an exploded perspective view of a portion of the apparatus of the invention which includes the outer water jacket, the inner water jacket, the front support end plate, the movable brush mounting plate, and the commutator.

FIG. 6A is an exploded perspective view of a portion of the apparatus of the invention which includes a portion of the commutator, the inner, stationary magnet set, the armature winding assembly, the rear support end plate, the motor shaft, and the drive gear.

FIG. 6B is a exploded perspective view of the armature winding assembly along with the inner tubular axle and the commutator.

FIG. 6C is a partial perspective view the front support end plate and the roller-reception flange, wherein the front support end plate includes rollers.

FIG. 7 is a partially exploded perspective view of the armature winding assembly, including the inner tubular axle and the commutator.

FIG. 8 is a bottom view of the pole and coil unit shown in FIG. 7, taken along line 8-8 thereof.

FIG. 9 is a cross-sectional view of the armature winding assembly shown in FIG. 7.

FIG. 10 is a partially exploded end view of the armature winding assembly shown in FIG. 9, taken along line 10-10 thereof.

FIG. 11 is a top view of the embodiment of the invention shown in FIG. 1, taken along 11-11 thereof.

FIG. 12 is an enlarged cross-sectional view of the portion of the embodiment of the invention shown in FIG. 11, taken along line 12-12 thereof.

FIG. 13 is a front view of the portion of the embodiment of the invention shown in FIG. 12, taken along line 13-13 thereof.

FIG. 14 is a partial perspective view of a portion of the embodiment of the invention shown in FIG. 14.

### DESCRIPTION OF THE PREFERRED EMBODIMENT

With reference to the drawings, a new and improved electric motor apparatus embodying the principles and concepts of the present invention will be described.

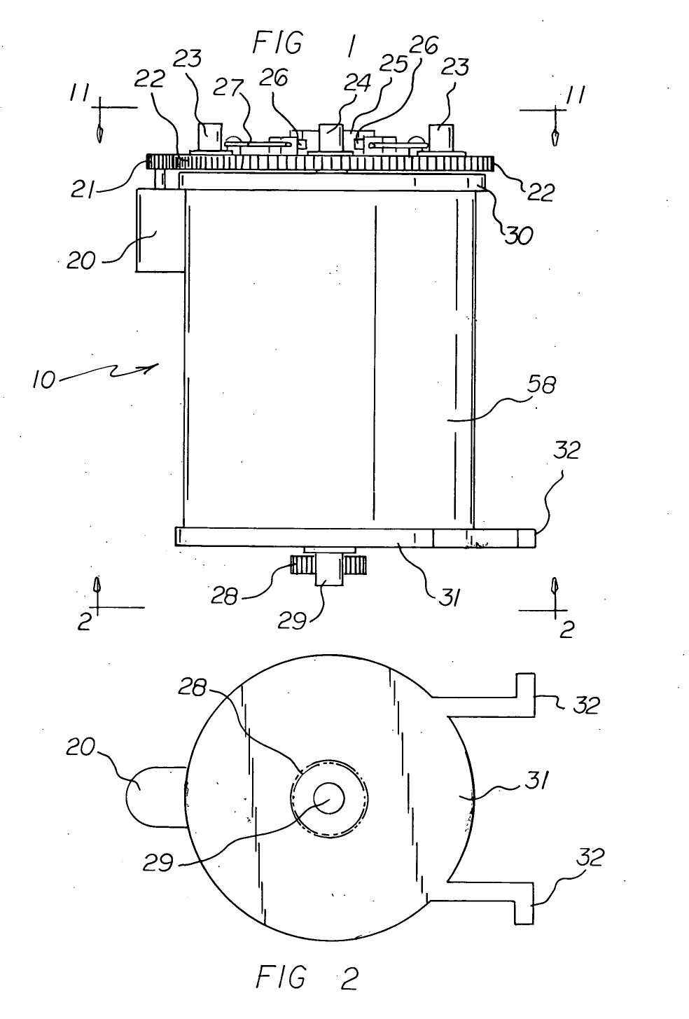

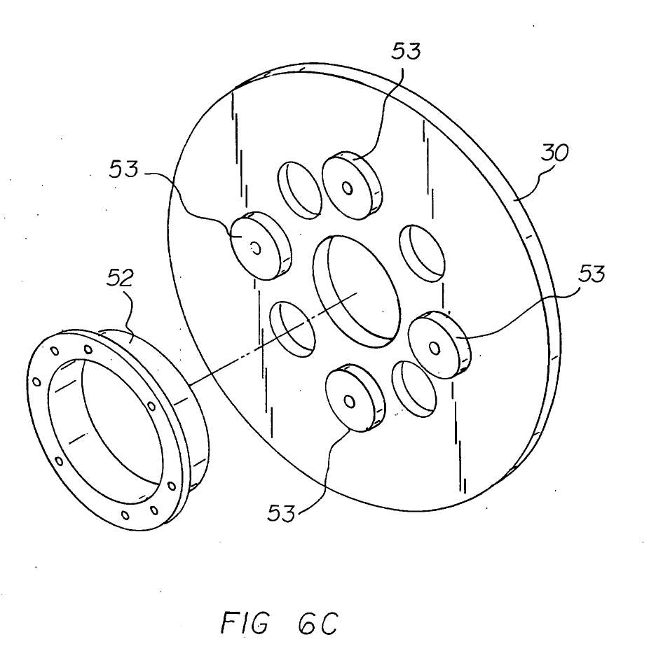

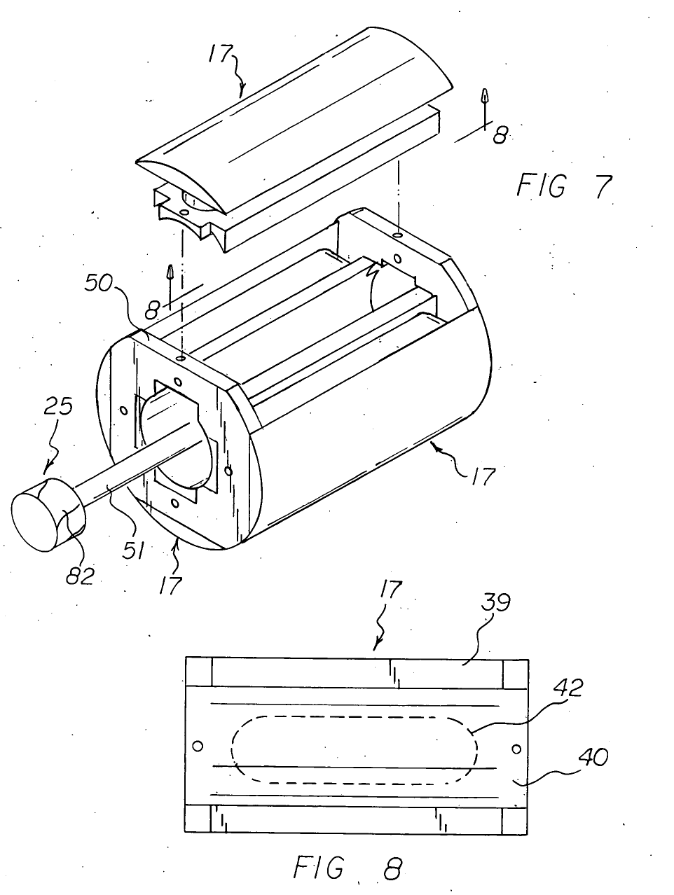

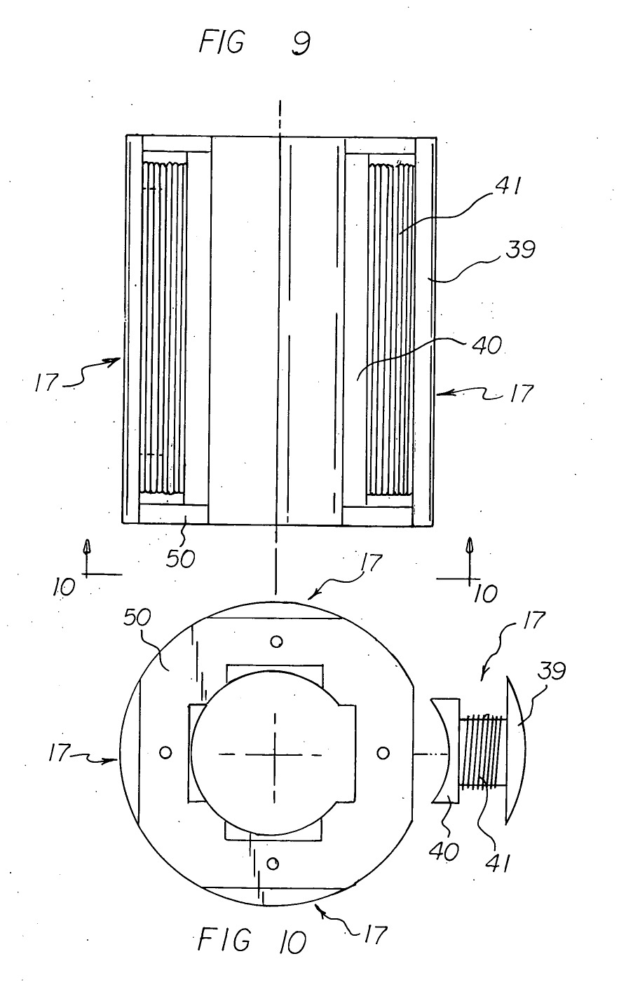

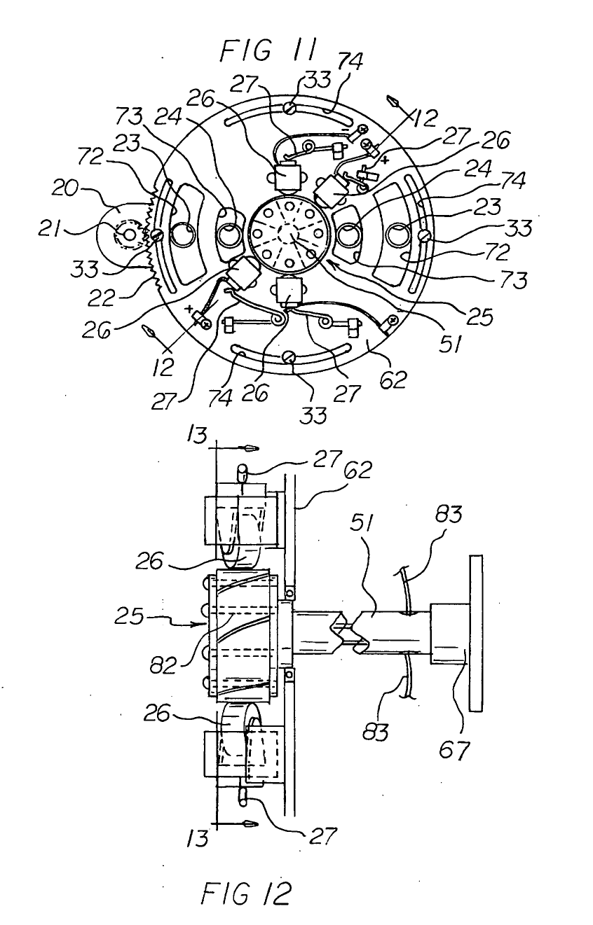

Turning to FIGS. 1-14, there is shown a preferred embodiment of the electric motor apparatus of the invention generally designated by reference numeral 10. In each of the figures, reference numerals are shown that correspond to like reference numerals that designate like elements shown in other figures.

Generally, a DC electric motor apparatus 10 includes a stationary magnet set which includes an outer, hollow-cylindrical stationary magnet set portion 86 and an inner, solid-cylindrical stationary magnet set portion 61 centrally located inside the outer, hollow-cylindrical stationary magnet set portion 86, wherein an armature-nesting space is located between the outer, hollow-cylindrical stationary magnet set portion 86 and the inner, solid-cylindrical stationary magnet set portion 61. A rotatable armature assembly includes a hollow-cylindrical armature winding set 87 which is received in the armature-nesting space. A drive assembly is connected to the rotatable armature assembly. Electric current pickup means are electrically connected to the rotatable armature assembly. Housing means are provided for housing the stationary magnet set, the rotatable armature assembly, a portion of the drive assembly, and a portion of the electric current pickup means.

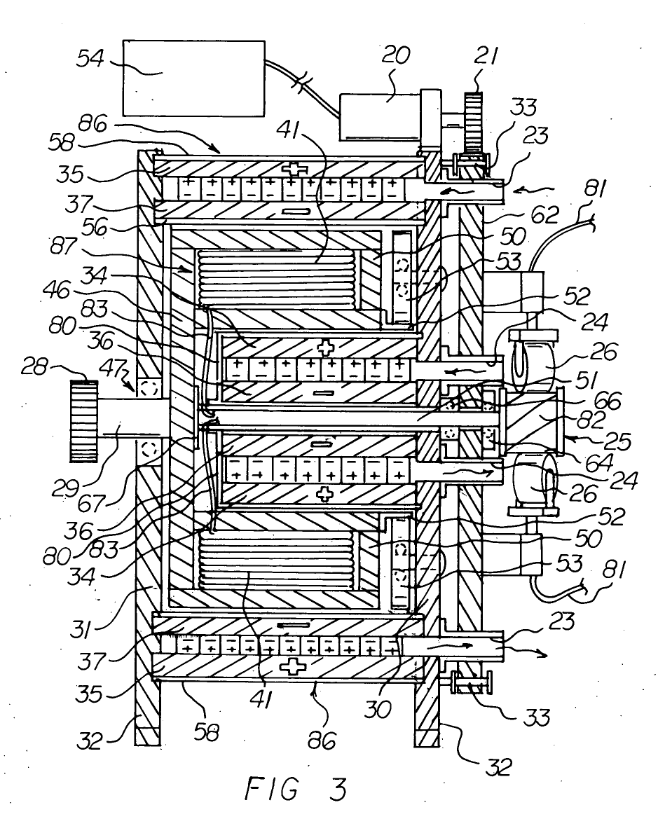

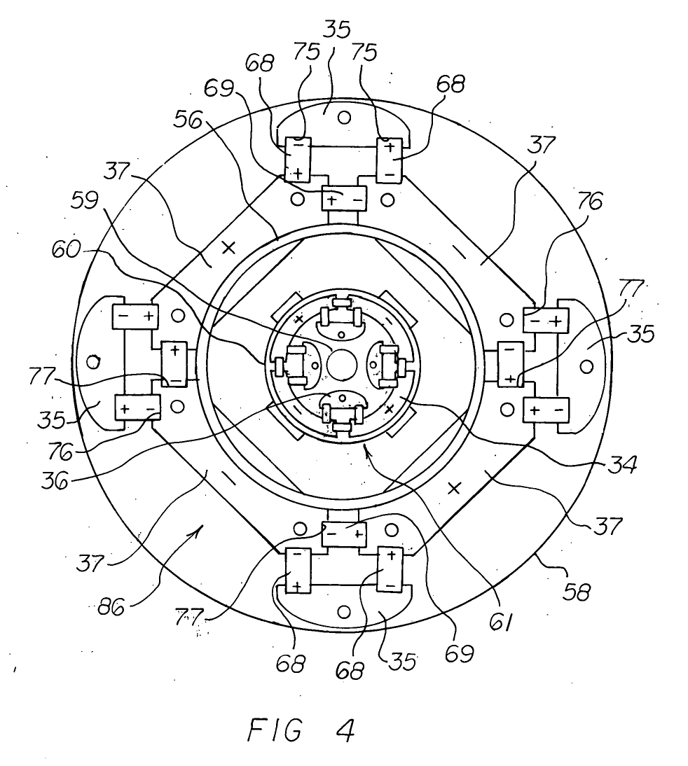

As shown in most detail in FIGS. 3 and 4, preferably, the outer, hollow-cylindrical stationary magnet set portion 86 includes a plurality of outer-shunt-to-inner-shunt magnets 68 distributed peripherally around the inner, solid-cylindrical stationary magnet set portion 61. A plurality of inner-shunt-to-inner-shunt magnets 69 are distributed peripherally around the inner, solid-cylindrical stationary magnet set portion 61. A plurality of outside, contoured magnet shunts 35 are distributed peripherally around the inner, solid-cylindrical stationary magnet set portion 61. A plurality of inside magnet shunts 37 are distributed peripherally around the inner, solid-cylindrical stationary magnet set portion 61.

Preferably, each of the outside, contoured magnet shunts 35 includes a pair of magnet-reception contours 75 which receive respective ends of the outer-shunt-to-inner-shunt magnets 68. Each of the inside magnet shunts 37 includes a pair of outer magnet-reception contours 76 for receiving respective ends of the outer-shunt-to-inner-shunt magnets 68 and includes a pair of side magnet-reception contours 77 for receiving respective ends of the inner-shunt-to-inner-shunt magnets 69. The outer-shunt-to-inner-shunt magnets 68 are arranged in two subsets of magnets, and the outer-shunt-to-inner-shunt magnets 68 in one subset are oriented in opposite polarity directions to the outer-shunt-to-inner-shunt magnets 68 in the other subset.

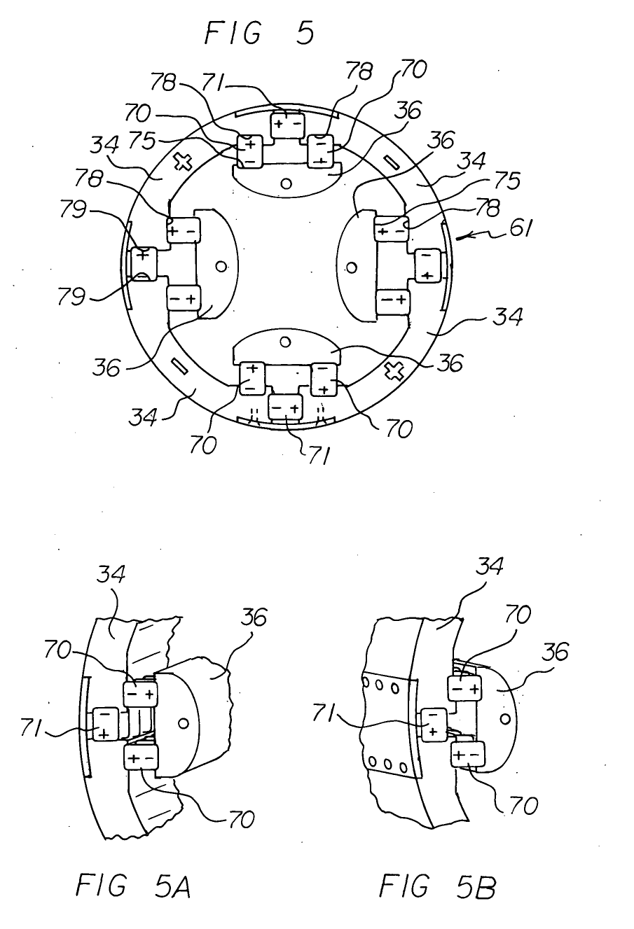

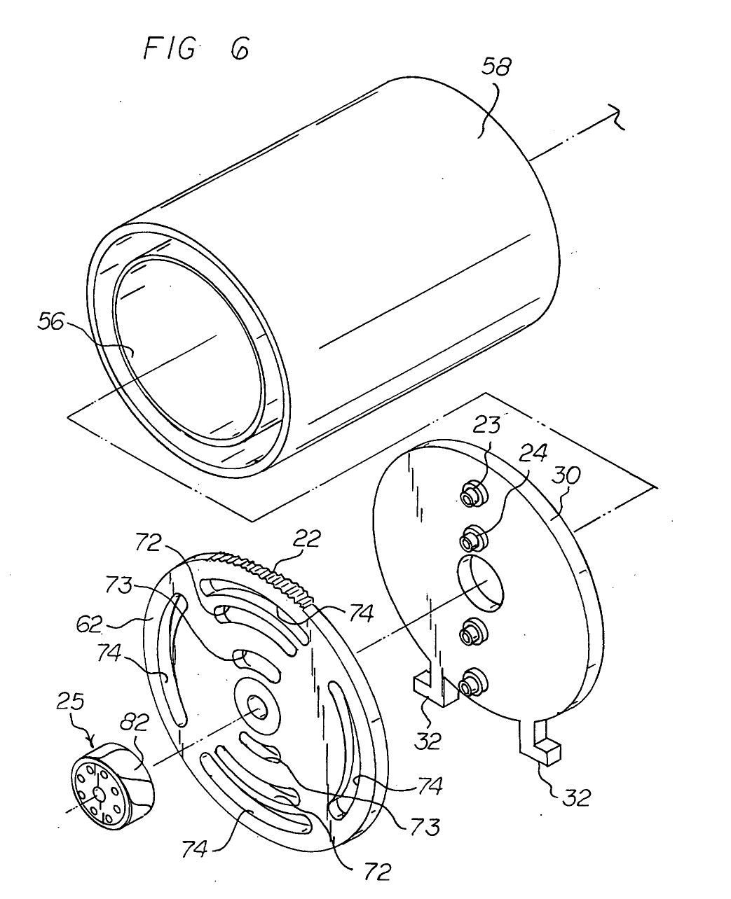

As shown in most detail in FIGS. 3, 5, 5A, and 5B, preferably, the inner, solid-cylindrical stationary magnet set portion 61 includes a plurality of outer-shunt-to-inner-shunt magnets 70 which are distributed radially inside the outer, hollow-cylindrical stationary magnet set portion 86. A plurality of inner-shunt-to-inner-shunt magnets 71 are distributed radially inside the outer, hollow-cylindrical stationary magnet set portion 86. A plurality of inside magnet shunts 36 are distributed radially inside the outer, hollow-cylindrical stationary magnet set portion 86. A plurality of outside magnet shunts 34 are distributed radially inside the outer, hollow-cylindrical stationary magnet set portion 86.

Each of the inside magnet shunts 36 includes a pair of magnet-reception contours 75 which receive respective ends of the outer-shunt-to-inner-shunt magnets 70. Each of the outside magnet shunts 34 includes a pair of inner magnet-reception contours 78 for receiving respective ends of the outer-shunt-to-inner-shunt magnets 70 and includes a pair of side magnet-reception contours 79 for receiving respective ends of the inner-shunt-to-inner-shunt magnets 71. The outer-shunt-to-inner-shunt magnets 70 are arranged in two subsets of magnets, and the outer-shunt-to-inner-shunt magnets 70 in one subset are oriented in opposite polarity directions to the outer-shunt-to-inner-shunt magnets 70 in the other subset.

Since both the outer, hollow-cylindrical stationary permanent magnet set portion 86 and the inner, solid-cylindrical stationary permanent magnet set portion 61 include inside magnet shunts 37 and outside magnet shunts 34, respectively, both the outer, hollow-cylindrical stationary permanent magnet set portion 86 and the inner, solid-cylindrical stationary permanent magnet set portion 61 can be smaller than conventional permanent magnet sets. In this respect, more permanent magnet sets can be used in conjunction with more commutator segments 82 to allow more pulses of electric power to the hollow-cylindrical armature winding set 87 per revolution. By analogy, this is like adding more cylinders to an internal combustion engine.

Principles of using cylindrical magnet arrays with shunts to produce intense magnetic fields are set forth in U.S. Pat. No. 5,879,549 and U.S. Pat. No. 6,426,000 by the present inventor, and U.S. Pat. No. 5,879,549 and U.S. Pat. No. 6,426,000 are hereby incorporated herein by reference, for their disclosure of such magnet array and shunt assemblies.

As shown in most detail in FIGS. 3, 6A, 6B, 7, 8, 9, and 10, preferably, the rotatable armature assembly includes a rear support plate 46, a front support plate 50, and the hollow-cylindrical armature winding set 87 is supported between the rear support plate 46 and front support plate 50 and distributed within the armature-nesting space. The drive assembly is connected to the rear support plate 46.

With the hollow-cylindrical armature winding set 87 fitting into the armature-nesting space between the outer, hollow-cylindrical stationary magnet set portion 86 and the inner, solid-cylindrical stationary magnet set portion 61, the hollow-cylindrical armature winding set 87 has a substantially open center. In this respect, a significant advantage in having the open center nature of the hollow-cylindrical armature winding set 87 is in allowing the plural electrically magnetized pole and coil units 17 to simultaneously interact with the permanent magnetic fields of both the outer, hollow-cylindrical stationary magnet set portion 86 and the inner, solid-cylindrical stationary magnet set portion 61. As a result, the attracting and repelling forces of the outer, hollow-cylindrical stationary magnet set portion 86 and the inner, solid-cylindrical stationary magnet set portion 61 on the hollow-cylindrical armature winding set 87 are much greater than provided by an ordinary or conventional electric motor which has just an outer stationary magnet set.

By further explanation, for example, the outer permanent magnets can have a POSITIVE magnetic pole field. The inner permanent magnets can have a NEGATIVE magnetic pole field in alignment with the POSITIVE magnetic pole field of the outer permanent magnets. When the hollow-cylindrical armature winding set 87 is electorally magnetized, the upper half of a respective winding has a NEGATIVE magnetic pole field, and the lower half has a POSITIVE magnetic pole field, thereby attracting the POSITIVE magnetic pole field of the outer permanent magnets and the NEGATIVE magnetic pole field of the inner permanent magnet shunts. As the commutator 25 rotates, the directions of the electric current applied to the hollow-cylindrical armature winding set 87 changes, and the magnetic polarity of the pole windings in the hollow-cylindrical armature winding set 87 reverse. As a result, instead of attracting, the magnetic fields repel each other.

Such advantages of the electric motor apparatus 10 of the invention explained above are in sharp contrast with an ordinary conventional electric motor in which the electrically generated magnetic fields would cancel out, by being next to each other at the armature shaft. Also, with the invention, the separated pole and coil units 17 of the hollow-cylindrical armature winding set 87 provide a doubling of electric motor power with the same electric current applied to the hollow-cylindrical armature winding set 87.

Preferably, the hollow-cylindrical armature winding set 87 includes plural armature winding assemblies. Each of the armature winding assemblies includes a plurality of pole and coil units 17 which are electrically connected together.

Preferably, each pole and coil unit 17 includes a top pole portion 39, a wire-reception post 42 connected to the top pole portion 39, a bottom pole portion 40 connected to the wire-reception post 42, a wire coil 41 supported by the wire-reception post 42, and armature wires 43 connected between respective wire coils 41. Also, the hollow-cylindrical armature winding set 87 includes a pair of coil-to-commutator wires 83 connected to a selected pair of the pole and coil units 17. The coil-to-commutator wires 83 are electrically connected to a commutator 25.

As shown in most detail in FIGS. 1, 3, and 6A, preferably, the drive assembly includes a motor shaft 29 connected to the rear support plate 46. External drive shaft splines 48 are located at a distal end of the motor shaft 29, and a drive gear 28 includes internal drive gear splines 49 that engage the external drive shaft splines 48. A drive shaft bearing assembly 47 is provided between the motor shaft 29 and the rear support end plate 31.

As shown in most detail in FIGS. 1, 3, 6A, 6B, 11, and 12, preferably, the electric current pickup means include an inner tubular axle 51 which includes wire-reception channels 44. The inner tubular axle 51 is supported by the rotatable armature assembly. A commutator 25 is connected to a front end of the inner tubular axle 51. A movable brush mounting plate 62 supported by the housing means, and roller brushes 26, supported by the movable brush mounting plate 62, are provided for contacting the commutator 25. The commutator 25 is electrically connected to coil-to-commutator wires 83.

The rear end of the inner tubular axle 51 fits into a inner tubular axle rear end fitting 67 that is attached to the rear support end plate 31. The roller brushes 26 are electrically connected to DC power wires 81. A bearing assembly 64 is situated on the inner tubular axle 51 between the movable brush mounting plate 62 and the commutator 25.

Preferably, the roller brushes 26 are located at positions opposite to each other with respect to the center of the movable brush mounting plate 62 and the commutator 25.

Preferably, the roller brushes 26 are set at a small angle off of normal to the commutator 25, whereby the roller brushes 26 provide both a sliding contact and a rolling contact with the commutator 25.

Preferably, the commutator 25 includes a plurality of commutator segments 82. Preferably, the commutator segments 82 are bias cut substantially as shown to align with the rolling brush edge surfaces in contact therewith.

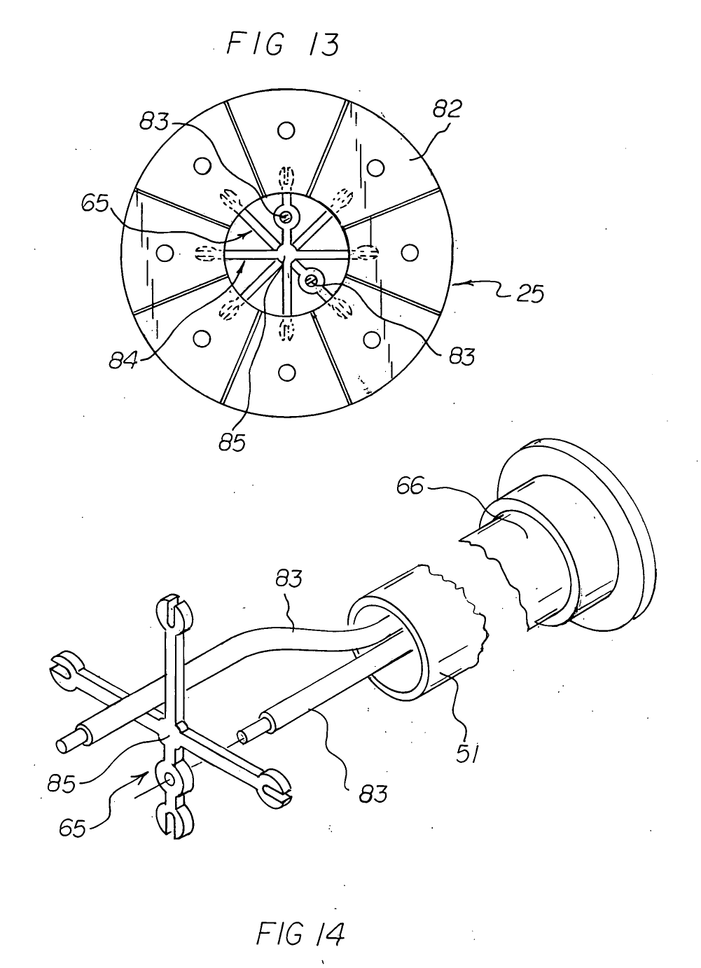

As shown in most detail in FIGS. 13 and 14, a pair of multiple-arm internal contact feeder shunts are connected between coil-to-commutator wires 83 and the commutator segments 82. The multiple-arm internal contact feeder shunts are housed inside the commutator 25 and electrically contact respective commutator segments 82 therein. By having the multiple-arm internal contact feeder shunts inside the commutator 25, there is no need to solder connection wires to the commutator 25. It is well known that wires soldered to commutator segments 82 are subject to separation due to centrifugal forces as the commutator 25 rotates. The presence of the multiple-arm internal contact feeder shunts inside the commutator 25 prevents any separation of the multiple-arm internal contact feeder shunts from the commutator 25 due to centrifugal forces.

The pair of multiple-arm internal contact feeder shunts includes a first multiple-arm internal contact feeder shunt 65 connected to one of the coil-to-commutator wires 83, wherein the first multiple-arm internal contact feeder shunt 65 includes pairs of first contact arms that are positioned opposite to each other around an arm center 85. The oppositely-positioned pairs of first contact arms are electrically connected to a first plurality of commutator segments 82. A second multiple-arm internal contact feeder shunt 84 is connected to the other of the coil-to-commutator wires 83, wherein the second multiple-arm internal contact feeder shunt 84 includes pairs of second contact arms that are positioned opposite to each other around an arm center 85. The oppositely-positioned pairs of second contact arms are electrically connected to a second plurality of commutator segments 82.

Each commutator segment 82 in the first plurality of commutator segments 82 is interspersed between two commutator segments 82 in the second plurality of commutator segments 82, and each commutator segment 82 in the second plurality of commutator segments 82 is interspersed between two commutator segments 82 in the first plurality of commutator segments 82. With this interspersed arrangement of the commutator segments 82, the oppositely-positioned pairs of first contact arms, and the oppositely-positioned pairs of second contact arms, when current is supplied to oppositely-located roller brushes 26, the oppositely-located commutator segments 82 that are contacted by the roller brushes 26 apply electric current to opposite pairs of pole and coil units 17 at the same time. That is, the wire coils 41 in oppositely-positioned pole and coil units 17 of the rotatable armature assembly are excited so that rotatable armature assembly is rotated by the changing making and breaking of electromagnetism in the rotatable armature assembly with respect to the constant magnetism in the outer, hollow-cylindrical stationary magnet set portion 86 and the inner, solid-cylindrical stationary magnet set portion 61 of the stationary magnet set. As a result, the rotating armature assembly is continuously rotated in the armature-nesting space, thereby providing a continuous driving rotation to the motor shaft 29 providing a continuous motor action of the motor shaft 29 and the drive gear 28.

As shown in most detail in FIGS. 1, 3, 11, and 12, brush-mounting plate movement means, supported by the housing means, are provided for rotating the movable brush mounting plate 62. Preferably, the brush-mounting plate movement means include gear teeth 22 located at the circumference of the movable brush mounting plate 62, a servo motor controller 54 which can be supported by the housing means, a servo motor 20 controlled by the servo motor controller 54, and a servo-powered gear wheel 21 driven by the servo motor 20. Rotation of the servo-powered gear wheel 21 controls rotation of the movable brush mounting plate 62.

Preferably, compression springs 27 are supported by the movable brush mounting plate 62 and are connected to the roller brushes 26 for pressing the roller brushes 26 on the commutator 25.

Operation of the movable brush mounting plate 62 is carried out as follows. In a utilization of the electric motor apparatus 10 of the invention in a vehicle, a computer or the like, along with appropriate sensors, senses the vehicle load and speed. The computer controls the servo motor controller 54, or the computer itself can be the servo motor controller 54. The servo motor controller 54 controls the servo motor 20 whose servo-powered gear wheel 21 meshes with the gear teeth 22 of the movable brush mounting plate 62. Operation of the servo motor 20 causes the movable brush mounting plate 62 to rotate around its center. When the movable brush mounting plate 62 rotates around its center and the commutator 25, variations occur in the time interval that the roller brushes 26 contact respective commutator segments 82. Variations of roller brush 26 contact with the respective commutator segments 82 can relate to time at beginning of contact, length of time of contact, and time at the end of contact. As a result, the timing and strength of the electric current running through the wire coils 41 in the pole and coil units 17 will vary, thereby varying the speed and power of rotation of the rotatable armature assembly and the motor shaft 29 driven thereby. Stated somewhat differently, variations in the advancement and/or retardation of the electric current through the wire coils 41 is controlled by the variations of the circular positions of the roller brushes 26 around the center of the movable brush mounting plate 62, and these variations are controlled by the servo motor controller 54 through the servo motor 20. More specifically, advancement of the timing can be used for a low load condition, such as already attained high vehicle speed. In addition, retardation of the timing can be used for a high load condition, such as during acceleration of the vehicle.

As shown in most detail in FIGS. 1, 3, and 6, preferably, the housing means include a front support end plate 30, a rear support end plate 31, a first outer housing jacket 58, and a first inner housing jacket 56. More specifically, the outer, hollow-cylindrical stationary magnet set portion 86 and the inner, solid-cylindrical stationary magnet set portion 61 are supported between the front support end plate 30 and the rear support end plate 31. The first outer housing jacket 58 and the first inner housing jacket 56 house the outer, hollow-cylindrical stationary magnet set portion 86.

Preferably, the rear support end plate 31 includes air vent holes 63. The air vent holes 63 provide for air cooling of the rotatable armature assembly. As described elsewhere herein, a first liquid cooling system is provided for cooling the outer, hollow-cylindrical stationary magnet set portion 86, and a second liquid cooling system is provided for cooling the inner, solid-cylindrical stationary magnet set portion 61.

The housing means further include a second inner jacket 59 and a second outer jacket 60. The second inner jacket 59 and the second outer jacket 60 are supported by the front support end plate 30, and the second inner jacket 59 and the second outer jacket 60 house the inner, solid-cylindrical stationary magnet set portion 61. Preferably, each of the front support end plate 30 and the rear support end plate 31 includes support feet 32.

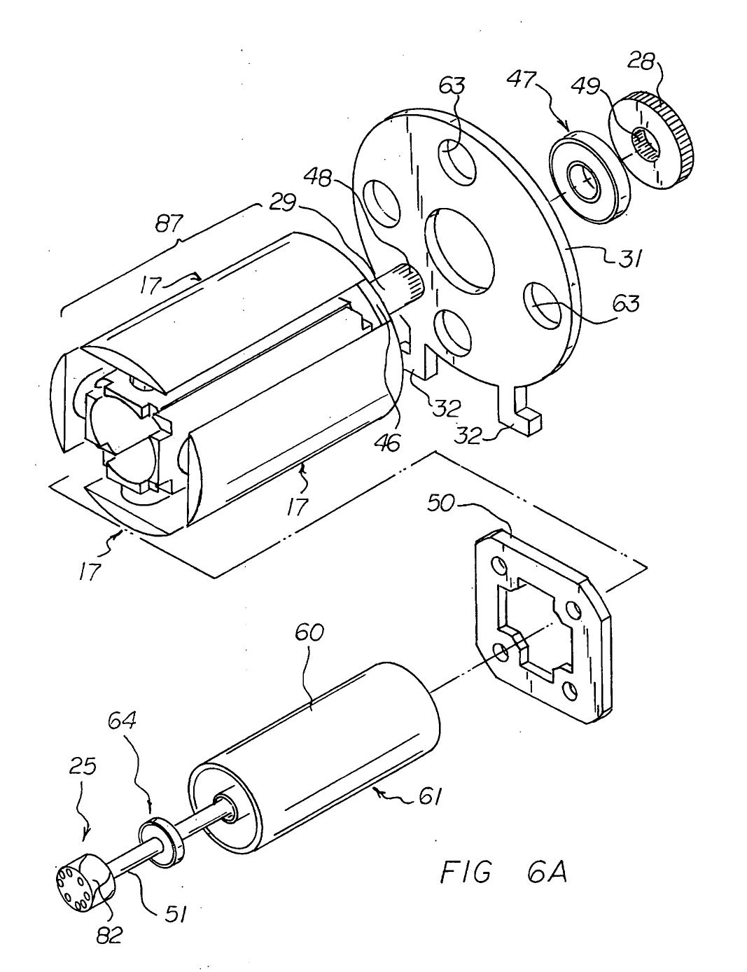

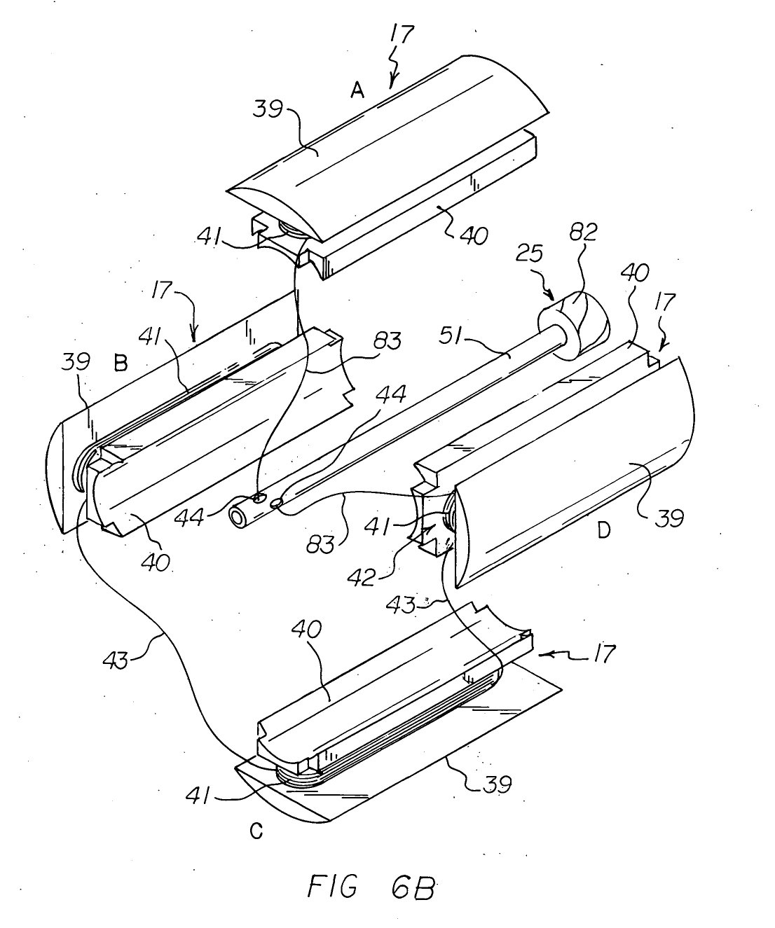

As shown in FIGS. 3 and 6C, preferably, rollers 53 are attached to the front support end plate 30, and a roller-reception flange 52 is attached to the rotatable armature assembly, wherein the rollers 53 ride on the roller-reception flange 52. The rollers 53 and the roller-reception flange 52 provide for the rotatable armature assembly to rotate within the armature-nesting space. In addition, the rollers 53 and the roller-reception flange 52 provide for stable rotation of the rotatable armature assembly.

As shown in most detail in FIGS. 1, 3, 6, and 6A, preferably, a first liquid cooling system is provided for cooling the outer, hollow-cylindrical stationary magnet set portion 86, and a second liquid cooling system is provided for cooling the inner, solid-cylindrical stationary magnet set portion 61.

More specifically, the first liquid cooling system includes outer liquid cooling inlet/outlet tubes 23, and a first coolant flow chamber is in communication with the outer liquid cooling inlet/outlet tubes 23. The first coolant flow chamber is defined by a first outer housing jacket 58, a first inner housing jacket 56, and a rear support end plate 31. The outer liquid cooling inlet/outlet tubes 23 have connection nipples for connecting to hoses (not shown) for carrying coolant fluid into and out from the first coolant flow chamber.

The second liquid cooling system includes inner liquid cooling inlet/outlet tubes 24 and a second coolant flow chamber is in communication with the inner liquid cooling inlet/outlet tubes 24. The second coolant flow chamber is defined by a second outer jacket 60, a second inner jacket 59, and a rear second chamber wall 80. The inner liquid cooling inlet/outlet tubes 24 have connection nipples for connecting to hoses (not shown) for carrying coolant fluid into and out from the second coolant flow chamber.

It is noted that the first outer housing jacket 58 and the first inner housing jacket 56 serve two functions. One function is to house the outer, hollow-cylindrical stationary magnet set portion 86, and the other function is to provide a first coolant flow chamber for the first liquid cooling system.

It is also noted that the second inner jacket 59 and second outer jacket 60 serve two functions. Once function is to house the inner, solid-cylindrical stationary magnet set portion 61, and the other function is to provide a second coolant flow chamber for the second liquid cooling system.

Preferably, the movable brush mounting plate 62 includes outer liquid cooling inlet/outlet tube slots 72 for receiving the outer liquid cooling inlet/outlet tubes 23 and includes inner liquid cooling inlet/outlet tube slots 73 for receiving the inner liquid cooling inlet/outlet tubes 24. The outer liquid cooling inlet/outlet tube slots 72 permit the movable brush mounting plate 62 to be rotated by the servo motor 20 without interference from the outer liquid cooling inlet/outlet tubes 23 or the nipples thereon. Similarly, the inner liquid cooling inlet/outlet tube slots 73 permit the movable brush mounting plate 62 to be rotated by the servo motor 20 without interference from the inner liquid cooling inlet/outlet tubes 24 or the nipples thereon.

Guide pins 33 are used to mount the movable brush mounting plate 62 onto the front support end plate 30. The movable brush mounting plate 62 includes mounting pin slots 74 for receiving the guide pins 33. The mounting pin slots 74 permit the movable brush mounting plate 62 to be rotated by the servo motor 20 without interference from the guide pins 33.

It is noted that with the embodiment of the invention described in detail herein, there are four pole and coil units 17, four outer, hollow-cylindrical stationary magnet sets, four inner, solid-cylindrical stationary magnet sets, four oppositely-positioned first contact arms, four oppositely-positioned second contact arms, and eight commutator segments 82.

In this respect, more generally, there can be “N” pole and coil units 17, “N” outer, hollow-cylindrical stationary magnet sets, “N” inner, solid-cylindrical stationary magnet sets, “N” oppositely-positioned first contact arms, “N” oppositely-positioned second contact arms, and 2×“N” commutator segments 82.

The components of the electric motor apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved electric motor apparatus that is low in cost, relatively simple in design and operation, and which may advantageously be used to provide an DC electric motor which has improved efficiency. With the invention, an electric motor apparatus provides a more efficient and more powerful electric motor which uses no more electricity than an ordinary electric motor. With the invention, an electric motor apparatus provides improved efficiency and power when applied to power devices that have variable loads and speeds, such as cars, trucks, and other types of vehicles. With the invention, an electric motor apparatus is provided which is able to change the timing of contact between the brushes and the commutator in response to variations in vehicle load and speed. With the invention, an electric motor apparatus is provided which changes the timing of contact between the brushes and the commutator without interference from structures in the liquid cooling system.

Furthermore, here are some additional benefits and advantages provided by the electric motor apparatus of the invention. The outside, magnet shunts 35 are contoured. The inside magnet shunts 37 can be made of iron. The inner tubular axle 51 is driven by the armature and drives the commutator 25. The rear support plate 46 and the front support plate 50 are made from non-magnetic materials. The rear support end plate 31 is made from non-magnetic materials and has vent holes 63. The vent holes 63 can have a fan cut to provide a fan ventilation effect for the rotatable armature assembly as the rotatable armature assembly rotates. The rollers 53 and the roller-reception flange 52 provide rotational stability for the rotatable armature assembly. The front support end plate 30 is made from non-magnetic materials. The guide pins 33 and the mounting pin slots 74 provide for smooth rotation of the movable brush mounting plate 62. The outer liquid cooling inlet/outlet tubes 23 and the inner liquid cooling inlet/outlet tubes 24 have end nipples for easy connection with a coolant-carrying hose. The bias cut commutator segments 82 allow for a roller brush 26 to both slide and roll on the commutator 25, thereby providing for a longer brush life.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. An electric motor apparatus, comprising:
stationary magnet set which includes an outer, hollow-cylindrical stationary magnet set portion and an inner, solid-cylindrical stationary magnet set portion centrally located inside said outer, hollow-cylindrical stationary magnet set portion, wherein an armature-nesting space is located between said outer, hollow-cylindrical stationary magnet set portion and said inner, solid-cylindrical stationary magnet set portion,
a rotatable armature assembly which includes a hollow-cylindrical armature winding set which is received in said armature-nesting space,
a drive assembly connected to said rotatable armature assembly,
electric current pickup means electrically connected to said rotatable armature assembly, and
housing means for housing said stationary magnet set, said rotatable armature assembly, a portion of said drive assembly, and a portion of said electric current pickup means.

2. The apparatus of claim 1 wherein said outer, hollow-cylindrical stationary magnet set portion includes:
a plurality of outer-shunt-to-inner-shunt magnets distributed peripherally around said inner, solid-cylindrical stationary magnet set portion,
a plurality of inner-shunt-to-inner-shunt magnets distributed peripherally around said inner, solid-cylindrical stationary magnet set portion,
a plurality of outside, contoured magnet shunts distributed peripherally around said inner, solid-cylindrical stationary magnet set portion, and
a plurality of inside magnet shunts distributed peripherally around said inner, solid-cylindrical stationary magnet set portion,
wherein said each of said outside, contoured magnet shunts includes a pair of magnet-reception contours which receive respective ends of said outer-shunt-to-inner-shunt magnets,
wherein each of said inside magnet shunts includes a pair of outer magnet-reception contours for receiving respective ends of said outer-shunt-to-inner-shunt magnets and includes a pair of side magnet-reception contours for receiving respective ends of said inner-shunt-to-inner-shunt magnets, and
wherein said outer-shunt-to-inner-shunt magnets are arranged in two subsets of magnets, and said outer-shunt-to-inner-shunt magnets in one subset are oriented in opposite polarity directions to said outer-shunt-to-inner-shunt magnets in the other subset.

3. The apparatus of claim 1 wherein said inner, solid-cylindrical stationary magnet set portion includes:
a plurality of outer-shunt-to-inner-shunt magnets distributed radially inside said outer, hollow-cylindrical stationary magnet set portion,
a plurality of inner-shunt-to-inner-shunt magnets distributed radially inside said outer, hollow-cylindrical stationary magnet set portion,
a plurality of inside magnet shunts distributed radially inside said outer, hollow-cylindrical stationary magnet set portion, and
a plurality of outside magnet shunts distributed radially inside said outer, hollow-cylindrical stationary magnet set portion,
wherein said each of said inside magnet shunts includes a pair of magnet-reception contours which receive respective ends of said outer-shunt-to-inner-shunt magnets,
wherein each of said outside magnet shunts includes a pair of inner magnet-reception contours for receiving respective ends of said outer-shunt-to-inner-shunt magnets and includes a pair of side magnet-reception contours for receiving respective ends of said inner-shunt-to-inner-shunt magnets, and
wherein said outer-shunt-to-inner-shunt magnets are arranged in two subsets of magnets, and said outer-shunt-to-inner-shunt magnets in one subset are oriented in opposite polarity directions to said outer-shunt-to-inner-shunt magnets in the other subset.

4. The apparatus of claim 1 wherein said rotatable armature assembly includes:
a rear support plate,
a front support plate, and
said hollow-cylindrical armature winding set is supported between said rear support plate and front support plate and distributed within said armature-nesting space,
wherein said drive assembly is connected to said rear support plate.

5. The apparatus of claim 4 wherein said hollow-cylindrical armature winding set includes plural armature winding assemblies.

6. The apparatus of claim 5 wherein each of said armature winding assemblies includes a plurality of pole and coil units which are electrically connected together.

7. The apparatus of claim 6 wherein each pole and coil unit includes:
a top pole portion,
a wire-reception post connected to said top pole portion,
a bottom pole portion connected to said wire-reception post,
a wire coil supported by said wire-reception post, and
armature wires connected between respective wire coils.

8. The apparatus of claim 6 wherein said hollow-cylindrical armature winding set includes a pair of coil-to-commutator wires connected to a selected pair of said pole and coil units.

9. The apparatus of claim 1 wherein said drive assembly includes:
a motor shaft connected to said rear support plate,
external drive shaft splines located at a distal end of said motor shaft, and
a drive gear which includes internal drive gear splines that engage said external drive shaft splines.

10. The apparatus of claim 1 wherein said electric current pickup means include:
an inner tubular axle which includes wire-reception channels, wherein said inner tubular axle is supported by said rotatable armature assembly,
a commutator connected to a front end of said inner tubular axle,
a movable brush mounting plate supported by said housing means, and
roller brushes, supported by said movable brush mounting plate, for contacting said commutator,
wherein said commutator is electrically connected to coil-to-commutator wires.

11. The apparatus of claim 10 wherein said roller brushes are located at positions opposite to each other with respect to the center of said movable brush mounting plate and said commutator.

12. The apparatus of claim 10 wherein said roller brushes are set at a small angle off of normal to said commutator, whereby said roller brushes provide both a sliding contact and a rolling contact with said commutator.

13. The apparatus of claim 10 wherein said commutator includes a plurality of commutator segments.

14. The apparatus of claim 13 wherein said commutator segments are bias cut.

15. The apparatus of claim 13, further including:
a pair of multiple-arm internal contact feeder shunts connected between coil-to-commutator wires and said commutator segments.

16. The apparatus of claim 15 wherein said multiple-arm internal contact feeder shunts are housed inside said commutator and electrically contact respective commutator segments therein.

17. The apparatus of claim 16 wherein said pair of multiple-arm internal contact feeder shunts includes:
a first multiple-arm internal contact feeder shunt connected to one of said coil-to-commutator wires, wherein said first multiple-arm internal contact feeder shunt includes pairs of first contact arms that are positioned opposite to each other around an arm center, and wherein said oppositely-positioned pairs of first contact arms are electrically connected to a first plurality of commutator segments, and
a second multiple-arm internal contact feeder shunt connected to the other of said coil-to-commutator wires, wherein said second multiple-arm internal contact feeder shunt includes pairs of second contact arms that are positioned opposite to each other around an arm center, and wherein said oppositely-positioned pairs of second contact arms are electrically connected to a second plurality of commutator segments,
wherein each commutator segment in said first plurality of commutator segments is interspersed between two commutator segments in said second plurality of commutator segments, and wherein each commutator segment in said second plurality of commutator segments is interspersed between two commutator segments in said first plurality of commutator segments.

18. The apparatus of claim 10, further including:
brush-mounting plate movement means, supported by said housing means, for rotating said movable brush mounting plate.

19. The apparatus of claim 18 wherein said brush-mounting plate movement means include:
gear teeth located at the circumference of said movable brush mounting plate,
a servo motor controller supported by said housing means,
a servo motor controlled by said servo motor controller, and
a servo-powered gear wheel driven by said servo motor,
wherein rotation of said servo-powered gear wheel controls rotation of said movable brush mounting plate.

20. The apparatus of claim 10, further including:
compression springs supported by said movable brush mounting plate and connected to said roller brushes, for urging said roller brushes on said commutator.

21. The apparatus of claim 1 wherein said housing means include:
a front support end plate,
a rear support end plate,
a first outer housing jacket, and
a first inner housing jacket,
wherein said outer, hollow-cylindrical stationary magnet set portion and said inner, solid-cylindrical stationary magnet set portion are supported between said front support end plate and said rear support end plate, and
wherein first outer housing jacket and said first inner housing jacket house said outer, hollow-cylindrical stationary magnet set portion.

22. The apparatus of claim 21 wherein said rear support end plate includes air vent holes.

23. The apparatus of claim 21 wherein said housing means further include:
a second inner jacket, and
a second outer jacket,
wherein said second inner jacket and said second outer jacket are supported by said front support end plate, and
wherein said second inner jacket and said second outer jacket house said inner, solid-cylindrical stationary magnet set portion.

24. The apparatus of claim 21 wherein each of said front support end plate and said rear support end plate includes support feet.

25. The apparatus of claim 21, further including:
rollers attached to said front support end plate, and
a roller-reception flange attached to said rotatable armature assembly, wherein said rollers ride on said roller-reception flange,
wherein said rollers and said roller-reception flange provide for said rotatable armature assembly to rotate within said armature-nesting space.

26. The apparatus of claim 1, further including:
a first liquid cooling system for cooling said outer, hollow-cylindrical stationary magnet set portion, and
a second liquid cooling system for cooling said inner, solid-cylindrical stationary magnet set portion.

27. The apparatus of claim 26 wherein said first liquid cooling system includes:
outer liquid cooling inlet/outlet tubes, and
a first coolant flow chamber connected to said outer liquid cooling inlet/outlet tubes,
wherein said first coolant flow chamber is defined by a first outer housing jacket, a first inner housing jacket, and a rear support end plate.

28. The apparatus of claim 26 wherein said second liquid cooling system includes:
inner liquid cooling inlet/outlet tubes,
a second coolant flow chamber connected to said inner liquid cooling inlet/outlet tubes,
wherein said second coolant flow chamber is defined by a second outer jacket, a second inner jacket, and a rear second chamber wall.
